(19) United States
(12) Patent Application Publication
(10) Pub. No.: US 2009/0187636 A1
(43) Pub. Date: Jul. 23, 2009

(54) MAIL SENDING AND RECEIVING APPARATUS AND MAIL SENDING AND RECEIVING SYSTEM

(75) Inventors: Atsushi UCHIYAMA, Nagano (JP); Jun YAMAZAKI, Nagano (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/359,245

(22) Filed: Jan. 23, 2009

(30) Foreign Application Priority Data
Jan. 23, 2008 (JP) 2008-012088

(51) Int. Cl. G06F 15/16; H04L 9/32

(52) U.S. Cl. 709/206; 726/5

(57) ABSTRACT

An apparatus of a mail sending and receiving system includes an authentication unit, an account determining unit, and an operation-instruction accepting unit. The authentication unit authenticates a login by a user to an entry account. The account determining unit reads account information, and determines one or more other accounts for which e-mail operations may be performed by an authenticated user. The operation-instruction accepting unit accepts an operation instruction causing an operation to be performed on an email in one of the determined accounts.

### CROSS-REFERENCE TO RELATED APPLICATIONS

This application is based upon and claims the benefit of priority of the prior Japanese Patent Application No. 2008-12088, filed on Jan. 23, 2008, the entire contents of which are incorporated herein by reference.

### FIELD

Embodiments of the present invention relate to mail sending and receiving programs stored on a computer-readable medium, a method of sending and receiving mail, mail sending and receiving apparatuses, and mail sending and receiving systems for sending and receiving e-mails.

### BACKGROUND

With popularization of e-mails, state institutions, local governments, private companies, and other organizations, for example, have been using more and more e-mails for sending and receiving information within and outside the state institutions, local governments, private companies, and other organizations.

Organizations may use mail addresses of the organization for contacting to the organization as a whole or mail addresses of subgroups of the organization (e.g., a department, a division, and a project team) for contacting the subgroups (herein referred to as representative addresses) in addition to personal mail address of persons in charge.

A related technique for transferring an e-mail directed to a representative address to multiple registered addresses as a broadcast mail are known (e.g., refer to a patent document 1, Japanese Laid-open Patent Publication No. 2002-82876). This allows confirming and sharing the content of the e-mail received at the representative address throughout the subgroup.

There is a webmail software (hereunder, called “web mail”) to read electronic mails on a browser software instead of on a mailer software.

### SUMMARY

An example of an embodiment of the present invention provides a mail sending and receiving apparatus for sending and receiving e-mails. The apparatus includes an authentication unit, a first memory, a second memory, an account determining unit and an operation-instruction accepting unit. The authentication unit performs authentication for login by a user to an entry account at which the user manages e-mails. The first memory stores account information identifying one or more other accounts for which the user is allowed to perform operations involving the e-mails. The second memory stores mail information relating to the e-mails. The account determining unit reads the account information from the first memory, and determines the accounts for which the user is authenticated by the authentication unit and allowed to perform operations involving the e-mails with reference to the account information. The operation-instruction unit accepts an operation instruction for performing an operation involving an e-mail at any one of the accounts determined by the account determining unit.

According to an example of an embodiment of the present invention, the mail sending and receiving apparatus may also include a mail providing unit and a mail-information processing unit. The mail providing unit reads mail information regarding the e-mails of the accounts determined by the account determining unit from the second memory, and provides the mail information that has been read for each of the accounts determined by the account determining unit to the mail-information processing unit. The mail-information processing unit processes the mail information read by the mail-information providing unit and updates the mail information stored in the second memory according to the operation instruction accepted by the operation-instruction accepting unit.

Further, according to an example of an embodiment of the present invention, the mail sending and receiving apparatus may include a switching-instruction accepting unit. The switching instruction accepting unit accepts a switching instruction and switches the account for which the mail information is provided by the mail-information providing unit from one account to another account among the accounts determined by the account determining unit.

According to an example of an embodiment of the present invention, the emails include Web mails and the operations performed by the mail sending and receiving apparatus include Web mail operations.

According to example of an embodiment of the present invention, the mail sending and receiving apparatus performs Web mail operations on Web mail. The structure and operations of mail sending and receiving apparatus provide increased functionality to a user and allows a user to perform operations on emails, including Web mails, that are not capable of being performed in related and/or conventional Web based mail systems.

It is to be understood that both the foregoing summary description and the following detailed description are explanatory as to some embodiments of the present invention, and not restrictive of the present invention as claimed.

### BRIEF DESCRIPTION OF THE DRAWINGS

Embodiments are illustrated by way of example and not limited by the following figures.

FIG. 1 depicts an overview of an example of an embodiment of the present invention;

FIG. 2 depicts a system configuration according to an example of an embodiment of the present invention;

FIG. 3 depicts a hardware configuration of a mail server according to an example of an embodiment of the present invention;

FIG. 4 depicts operations of a mail server according to an example of an embodiment of the present invention;

FIG. 5 depicts a data structure of an association table according to an example of an embodiment of the present invention;

FIG. 6 depicts a data structure of a group table according to an example of an embodiment of the present invention;

FIG. 7 depicts a data structure of an address table according to an example of an embodiment of the present invention;

FIG. 8 depicts a data structure of a mail opening table according to an example of an embodiment of the present invention;

FIG. 9 is a flowchart depicting a mailbox process according to an example of an embodiment of the present invention;

FIG. 10 depicts e-mail operation in a mail system according to an example of an embodiment of the present invention;

FIG. 11 depicts associations between user accounts and representative accounts based on account information according to an example of an embodiment of the present invention;

FIG. 12 depicts a log-in screen according to an example of an embodiment of the present invention;

FIG. 13 depicts a post-log-in screen according to an example of an embodiment of the present invention;

FIG. 14 depicts an account display screen for a personal address according to an example of an embodiment of the present invention;

FIG. 15 depicts an account display screen for a representative address according to an example of an embodiment of the present invention; and

FIG. 16 depicts a reply-mail creating screen according to an example of an embodiment of the present invention.

### DESCRIPTION OF EMBODIMENTS

In the figures, dimensions and/or proportions may be exaggerated for clarity of illustration. It will also be understood that when an element is referred to as being “connected to” another element, it may be directly connected or indirectly connected, i.e., intervening elements may also be present. Further, it will be understood that when an element is referred to as being “between” two elements, it may be the only element layer between the two elements, or one or more intervening elements may also be present. Like reference numerals refer to like elements throughout.

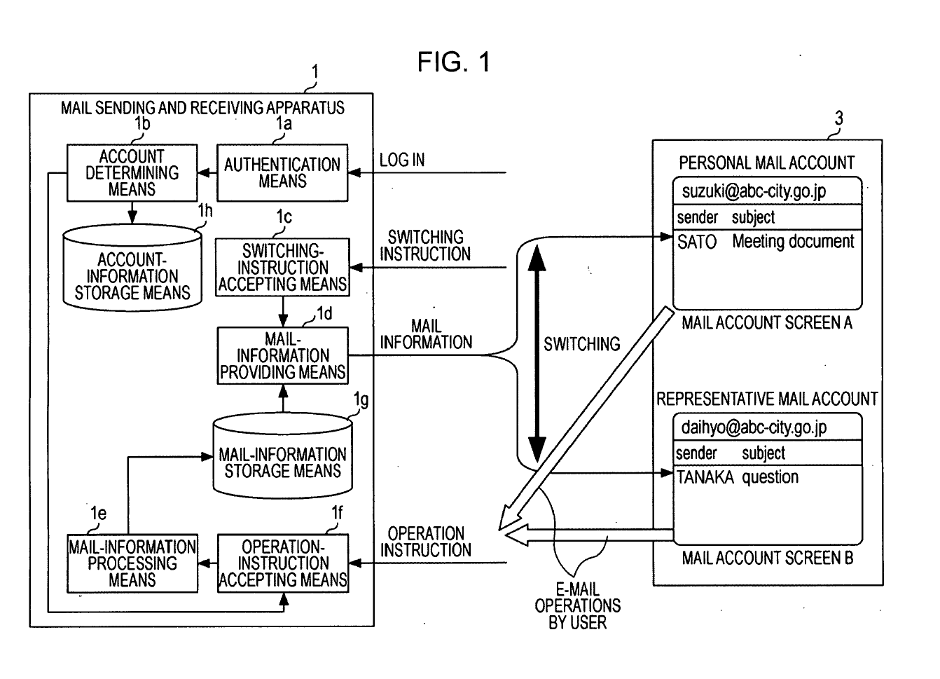

A mail sending and receiving apparatus depicted in FIG. 1 sends and receives e-mails. Furthermore, the mail sending and receiving apparatus manages a plurality of mail accounts. A mail sending and receiving apparatus 1 may be implemented by a computer functioning as described below in response to executing a mail sending and receiving program stored on a computer-readable medium. As depicted in FIG. 1, the mail sending and receiving apparatus 1 includes an authentication unit 1a, an account determining unit 1b, a switching-instruction accepting unit 1c, a mail-information providing unit 1d, a mail-information processing unit 1e, an operation-instruction accepting unit 1f, a mail-information storage unit 1g (e.g., a memory, for example), and an account-information storage unit 1h (e.g., a memory, for example.

The authentication unit 1a performs authentication for login by a user to an entry account from which the user may manage e-mails. The authentication may ensure the validity of a login by the user.

The account determining unit 1b reads account information from the account-information storage unit 1h, and determines one or more other accounts for which the user is authenticated by the authentication unit 1a. If the user is authenticated, the user may be allowed to perform e-mail operations for the one or more other accounts based on the account information, for example.

The switching-instruction accepting unit 1c accepts a switching instruction for switching an account for which mail information is provided by the mail-information providing unit 1d from one account to another among the accounts determined by the account determining unit 1b (e.g., the accounts permitted by the account determining unit 1b for e-mail operations, for example). The switching instruction may be issued by a user who reads e-mails in order to switch e-mails displayed on a display screen 3, for example.

The mail-information providing unit 1d reads, from the mail-information storage unit 1g, mail information regarding e-mails of the accounts determined by the account determining unit 1b. The mail-information providing unit 1d also provides the mail information that has been read for each of the accounts determined by the account determining unit 1b to the display screen 3, for example. On the basis of the mail information provided by the mail-information providing unit 1d, the content of e-mails and other information related to an account that the user wishes to use for reading are displayed on a display screen on which the user may read e-mails.

The mail-information providing unit 1d switches the account for which mail information is read from the mail-information storage unit 1g from one account to another account according to the switching instruction accepted by the switching-instruction accepting unit 1c. Accordingly, the mail information provided by the mail-information providing unit 1d is switched from one account to another account according to the switching instruction.

Thus, it is possible to switch the content displayed on the display screen 3, for example, between a mail account screen A showing e-mails sent to a personal mail account and a mail account screen B showing e-mails sent to a representative mail account. The switching instruction may be input by a user, for example.

The mail-information processing unit 1e processes the mail information read by the mail-information providing unit 1d and updates the mail information stored in the mail-information storage unit 1g according to an operation instruction. The operation instruction may be accepted by the operation-instruction accepting unit 1f.

The operation-instruction accepting unit 1f accepts an operation instruction for an operation involving an e-mail at any one of the accounts determined by the account determining unit 1b.

The mail-information storage unit 1g stores mail information relating to e-mails. The mail information may includes a body, a source address, a destination address, a date and time of sending, etc. for each e-mail. The content and other information of e-mails are displayed on the display screen 3 based on the corresponding mail information.

The account-information storage unit 1h stores account information identifying accounts at which users are allowed to perform e-mail operations.

With the mail sending and receiving apparatus 1 described above, the authentication unit 1a performs authentication for login. The account determining unit 1b reads account information and determines accounts in which e-mail operations are allowed. The operation-instruction accepting unit 1f accepts an operation instruction. The mail-information providing unit 1d reads mail information of e-mails of the accounts determined by the account determining unit 1b, and provides mail information that has been read for each of the determined accounts. The mail-information processing unit 1e processes the mail information and updates the mail information according to the operation instruction. The switching-instruction accepting unit 1c accepts a switching instruction. According to the switching instruction, the mail-information providing unit 1d switches the account of mail information to another account. It is possible to switch an e-mail account at which the mail sending and receiving apparatus 1 allows a user to perform operations among a plurality of accounts according to a switching instruction input by the user without performing a second login, for example.

Now, the embodiment will be described in detail with reference to the drawings.

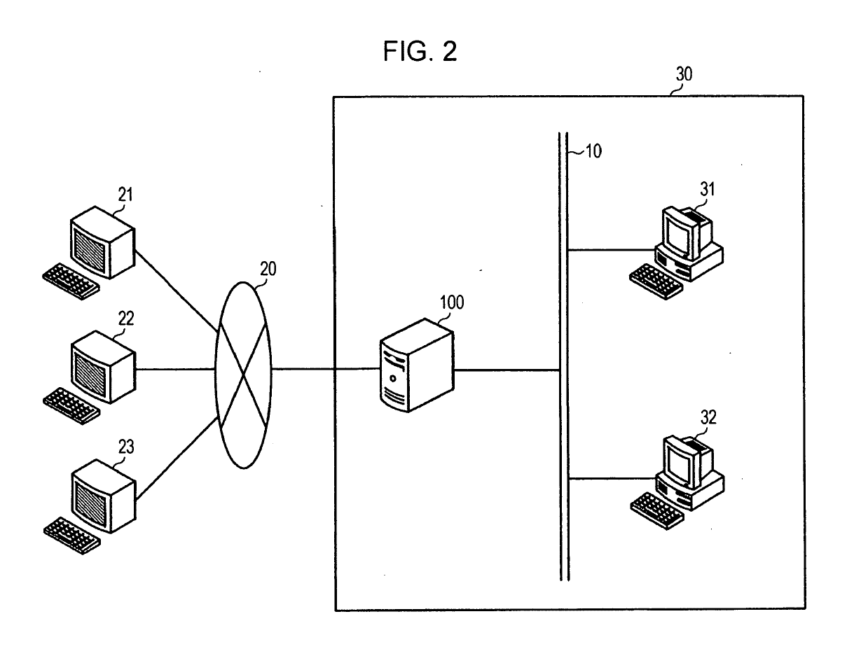

FIG. 2 depicts a system configuration. In particular, the mail system shown in FIG. 2 is a system for sending and receiving e-mails within an organization 30 and between the organization 30 and external devices and/or other organizations represented in FIG. 2 by the terminal apparatuses 21, 22, and 23, for example.

In the case of a company, for example, a department may be considered as an organization, or the entire company may be considered as an organization, for example. Similarly, in the case of a local government, for example, a section may be considered as an organization, or the entire government may be considered as an organization.

Referring to FIG. 2, terminal apparatuses 31, 32, . . . are connected via a local area network (LAN) 10 to a mail server 100 for sending and receiving e-mails. Furthermore, the mail server 100 is connected to external terminal apparatuses 21, 22, 23, . . . via the Internet 20.

The mail server 100 sends and receives e-mails within the organization 30 and outside of the organization 30. Furthermore, the mail server 100 manages e-mail accounts within the organization 30.

The mail server 100 stores internal mails created by users inside the organization 30 by using browsers on the terminal apparatuses 31 and 32, for example. Furthermore, the mail server 100 receives e-mails sent from the outside to the inside of the organization 30 via the Internet 20 and stores the e-mails. The receiving and storing of the emails may be implemented by a mail-opening-information storage unit 140, for example. The mail-opening-information storage unit 140 is described later.

Furthermore, the mail server 100 has a function of allowing users, as recipients of e-mails, to perform email operations on the e-mails as Web mails in accordance with requests from the users using browsers on terminal apparatuses 31 and 32, for example. The e-mail operations refer to operations relating to management of e-mails, such as creating and sending a new e-mail, reading an e-mail received or sent, creating a reply mail to a received e-mail, deleting an e-mail received or sent at an account being used, and temporarily saving an e-mail being created, for example.

When a user wishes to perform e-mail operations, the user is requested to enter a user ID and a password from a browser on one of the terminal apparatuses 31 and 32, for example. The user may be allowed to perform operations on internal mails written to the user from the inside of the organization 30 and external mails sent to the user from the outside of the organization 30 only when the user ID and password match authentication information. The authentication information may be registered in advance, for example. On occasion of an e-mail operation, the mail server 100 sends via the LAN 10 information representing the content of an e-mail relevant to the user's operation to the browser of one of the terminal apparatuses 31 and 32 (e.g., the terminal apparatus 31, for example) that the user is operating. Upon receiving the information representing the content of the e-mail, the terminal apparatus 31 displays the content of the e-mail on the browser of the terminal apparatus 31. With reference to the content of the e-mail displayed on the browser, the user may perform an e-mail operation.

Furthermore, the mail server 100 sends e-mails created by using the browsers of the terminal apparatuses 31 and 32 to devices outside of the organization 30 via the Internet 20. On occasion of sending an e-mail, the mail server 100 may accept a user's request for creating and sending an e-mail according to the Hypertext Transfer Protocol (HTTP), and sends the e-mail to a destination (e.g., a user of the terminal apparatus 21, for example). The destination may be specified by the user according to the Simple Mail Transfer Protocol (SMTP), the Post Office Protocol (POP)/Internet Message Access Protocol (IMAP), etc., for example.

Herein, e-mails that are stored under management by the mail server 100 and that may be operated on by browsers used by users within the organization 30 only from the terminal apparatuses 31 and 32 within the organization 30 are referred to as “Web mails”. Within the organization 30, the users may perform reading and other operations on external mails sent from the outside of the organization 30 to the mail server 100 as well as internal mails as Web mails.

Furthermore, the users belonging to the organization 30 may be allowed to read e-mails on the mail system by connecting to the mail server 100 from external terminal apparatuses (not shown) outside the organization 30 via the Internet 20. Also in this case, similar to the case of using one of the terminal apparatuses 31 and 32 inside the organization 30, the users belonging to the organization 30 undergo authentication for login based on user IDs and passwords by using terminals external to the organization 30 and connected to the Internet 20, for example. Thus, the users belonging to the organization 30 may access and read e-mails received at a representative address even when the users are located away from the organization 30.

E-mails that are created at the terminal apparatuses 31 and 32inside the organization 30 and exchanged among users within the organization 30 are referred to as “internal mails”. On the other hand, e-mails exchanged between users inside the organization 30 and users outside of the organization 30 via the Internet 20 and the mail server 100 are referred to as “external mails”.

Herein, “e-mails” include both internal mails, external mails, and Web mails. For example, an internal mail is created on the browser at one of the terminal apparatuses 31 and 32 located within the organization 30. A created internal mail is stored in the mail server 100 as a Web mail, for example, and only a user who has logged in by using an account within the organization 30 set as a destination of the internal mail may be allowed to perform operations involving the Web mail.

When an external mail is sent from inside the organization 30 to the outside of the organization 30, a user creates the external mail by using the browser at one of the terminal apparatuses 31 and 32. In response to a sending instruction input by the user, the external mail is sent temporarily from the mail server 100 via the Internet 20 to a mail server (not shown) that manages e-mails of a user at the destination, for example. Then, for example, the external mail is sent from the mail server that manages e-mails of the user at the destination to one of the external terminal apparatuses 21, 22 and 23 used by the user at the destination, for example.

As an example, a user of the terminal apparatus 31 may send an external mail to a user of the external terminal apparatus 21 using a mail address corresponding to a mail account managed by the mail server 100. In this case, according to a user's operation performed by using the browser at the terminal apparatus 31, upon creation of an e-mail addressed to the user of the terminal apparatus 21, the terminal apparatus 31 sends a body of the e-mail and a mail address of the user of the terminal apparatus 21 at the destination to the mail server 100 via the LAN 10. Upon receiving the mail address of the user of the terminal apparatus 21 at the destination and the mail body from the terminal apparatus 31, the mail server 100 sends the e-mail created by the user of the terminal apparatus 31 and including the mail body to the destination mail address.

On the other hand, when an external mail sent from the outside of the organization 30 via the Internet 20 is received by the mail server 100, similarly to the case of an internal mail, the external mail is stored at the mail server 100 as a Web mail. A user who has logged in by using an account within the organization 30 set as a destination of the external mail is allowed to perform operations involving the Web mail on the browser at one of the terminal apparatuses 31 and 32 inside the organization 30. Perhaps, only the user who has logged in by using an account within the organization 30 set as a destination of the external mail is allowed to perform operations involving the Web mail on the browser at one of the terminal apparatuses 31 and 32.

As described above, the mail server 100 sends information of documents created by users within the organization 30 by using the terminal apparatuses 31 and 32 as external mails to the outside of the organization 30. The mail server 100 also provides Web mails so that the users within the organization 30 may perform e-mail operations by using the browsers running on the terminal apparatuses 31 and 32 and so that other users within the organization 30 may perform operations involving created e-mails. As described above, the mail server 100 sends and receives e-mails to and from devices inside and outside of the organization 30 and manages received e-mails. With the above described mail server 100, it is possible to send an e-mail to addresses including destinations both inside and outside the organization 30.

Furthermore, external mails received from outside of the organization 30 and internal mails may be managed at the mail server 100 simply on the basis of source addresses without providing a particular distinction between the external mails and the internal mails. Further, both the external mails and the internal mails may be displayed substantially simultaneously on occasion of a user's operation at one of the terminal apparatuses 31 and 32, for example. Alternatively, however, as desired or needed, external mails and internal mails may be managed distinctly, and may also be displayed distinctly. As still another alternative, the mail server 100 may be configured to deal with only external mails or only internal mails, for example.

Furthermore, although the mail server 100 described above, manages Web mails, an independent apparatus different from the mail server 100, such as a second server, for example, may manage Web mails. Such server may be dedicated for only managing Web mails, or may have other functions as well.

The terminal apparatuses 21, 22, and 23 noted above are computers provided outside the organization 30 so that users outside the organization 30 may send e-mails, receive e-mails, and/or perform other operations involving e-mails.

The terminal apparatuses 31 and 32 noted above are computers provided inside the organization 30 so that users inside the organization 30 may use Web mails provided by the mail server 100. Each of the terminal apparatuses 31 and 32 has a function of using Web mails provided by the mail server 100, and a function of operating the mail server 100 to send e-mails to and receive e-mails from the outside of the organization 30 via the Internet 20, for example.

Next, a hardware configuration of the mail server 100 is described.

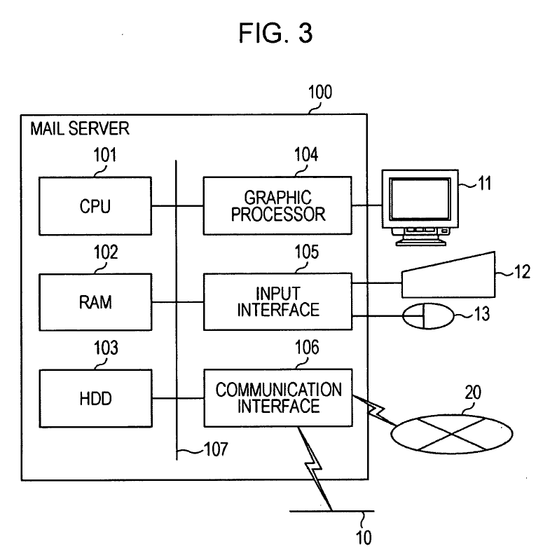

FIG. 3 depicts the hardware configuration of the mail server 100. The mail server 100 as a whole may be controlled by a central processing unit (CPU) 101. Referring to FIG. 3, the CPU 101 is connected to a random access memory (RAM) 102, a hard disk drive (HDD) 103, a graphic processor 104, an input interface 105, and a communication interface 106.

The RAM 102 temporarily stores at least part of an operating system (OS) program and application programs executed by the CPU 101. Furthermore, the RAM 102 stores various types of data needed for processing by the CPU 101. The HDD 103 stores the OS and application programs.

Still referring to FIG. 3, the graphic processor 104 is connected to a monitor 11. The graphic processor 104 displays images on a screen of the monitor 11 according to instructions from the CPU 101. The input interface 105 is connected to a keyboard 12 and a mouse 13. The input interface 105 sends signals sent from the keyboard 12 or the mouse 13 to the CPU 101 via a bus 107.

The communication interface 106 is connected to networks such as the LAN 10 and the Internet 20, for example. The communication interface 106 sends data to and receives data from other computers via these networks.

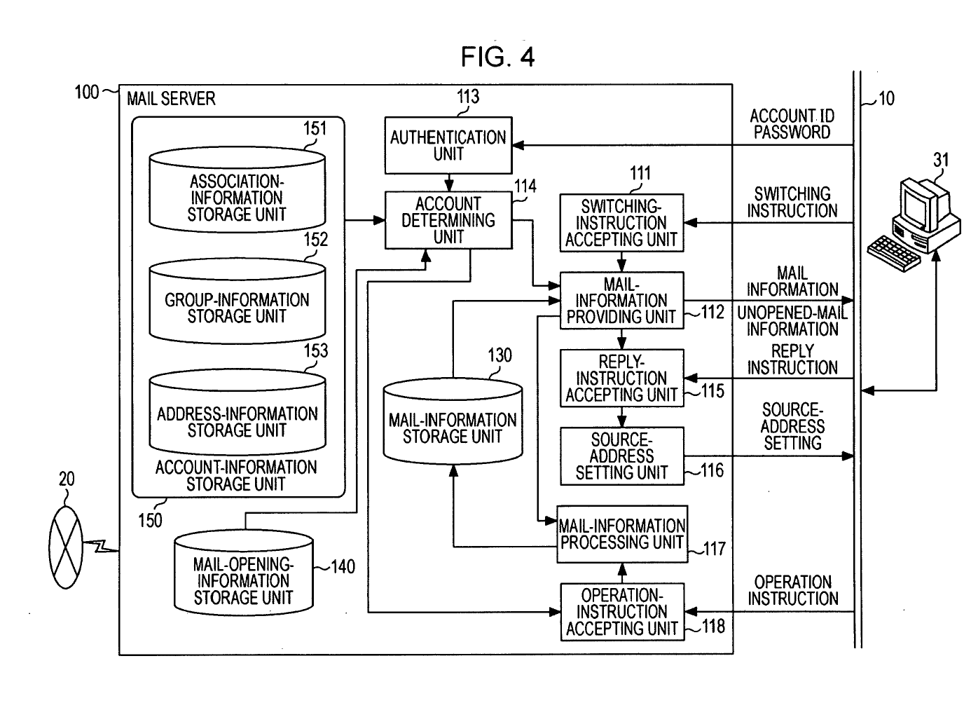

FIG. 4 depicts operations, which may be performed by a mail server 100. The mail server 100 sends and receives e-mails, and manages a plurality of accounts. For the purpose of management of a plurality of accounts, the mail server 100 includes a switching-request accepting unit 111, a mail-information providing unit 112, an authentication unit 113, an account determining unit 114, a reply-instruction accepting unit 115, a source-address setting unit 116, a mail-information processing unit 117, an operation-instruction accepting unit 118, a mail-information storage unit 130, a mail-opening-information storage unit 140, and an account-information storage unit 150.

Furthermore, the mail server 100 is connected via the LAN 10 to the terminal apparatus 31. The terminal apparatus 31 may be used by a user to perform e-mail operations. The terminal apparatus is connected via the Internet 20 to external terminal apparatuses 21, 22, and 23, for example (see FIG. 2).

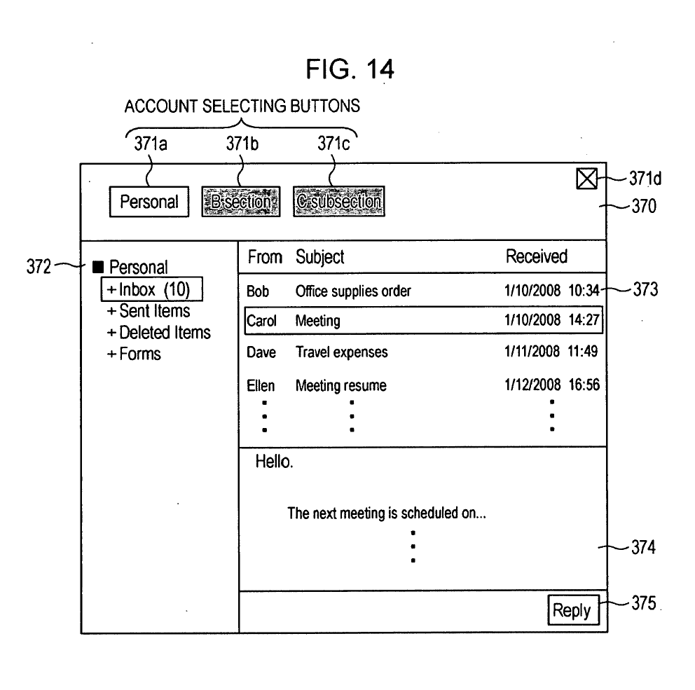

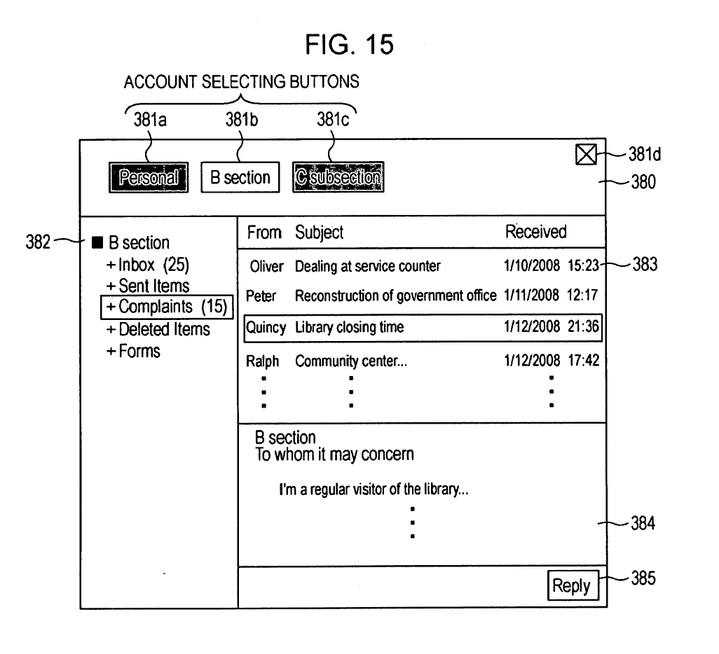

The switching-instruction accepting unit 111 accepts a switching instruction for switching an account for which mail information is provided by the mail-information providing unit 112 from one account to another account among accounts that a user is allowed to perform operations. The switching instruction is input by the user performing operations using the browser of the terminal apparatus 31. The switching instruction input to the terminal apparatus 31 is sent from the terminal apparatus 31 to the mail server 100 via the LAN 10, for example. When the user inputs the switching instruction, the user specifies an account for switching. The operation for switching is described later with reference to FIGS. 14 and 15.

The mail-information providing unit 112 reads mail information related to e-mails of accounts determined by the account determining unit 114 based on information stored in the mail-information storage unit 130. Furthermore, for each of the accounts that the account determining unit 114 determines the user is allowed to perform email operations, the mail-information providing unit 112 provides the mail information that has been read via the LAN 10 to the terminal apparatus 31 where the user performs the e-mail operations.

The mail-information providing unit 112 switches the account for which mail information is read from the mail-information storage unit 130 and provides the mail information to another account specified in the switching instruction accepted by the switching-instruction unit 111.

The mail-information providing unit 112 provides the terminal apparatus 31 via the LAN 10 with unopened mail information and opened mail information indicating whether any unopened mail exists in the accounts other than the account for which mail information is provided by the mail-information providing unit 112.

At this time, the mail-information providing unit 112 first reads mail opening information from the mail-opening-information storage unit 140 (e.g., a memory, for example). Then, the mail-information providing unit 112 generates unopened mail information and opened mail information with reference to the mail opening information read from the mail-opening-information storage unit 140 to indicate whether any unopened mail exists in the accounts determined by the account determining unit 114. Then, the mail-information providing unit 112 provides the unopened mail information and opened mail information to the terminal apparatus 31 a user is using to access the determined accounts.

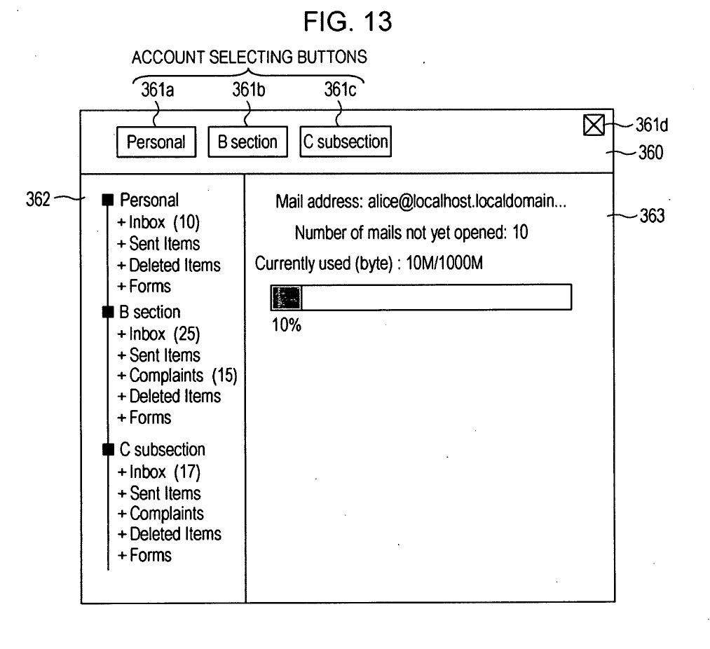

On the basis of the unopened mail information and opened mail information, information indicating whether any unopened mail exists is displayed on the browser of the terminal apparatus 31. The display of information regarding unopened mails and opened mails is further described later with reference to FIGS. 13 to 15.

The authentication unit 113, in order to ensure the validity of login by a user, performs authentication for user's login to an account for managing e-mails on the basis of an account ID, such as a user ID and a password associated with the account ID, for example. The user ID and password may be input to the terminal apparatus 31 by the user. Upon successful authentication, the mail server 100 permits login by the user using the terminal apparatus 31, and provides mail information to the user based on the account corresponding to the account ID used for authentication. Thus, the user may perform, by using the terminal apparatus 31, operations involving e-mails sent to the account corresponding to the account ID.

The account determining unit 114 reads account information from the account-information storage unit 150, and with reference to the account information, determines accounts in which the authenticated user is allowed to perform e-mail operations. The determination of accounts in which the user is allowed to perform e-mail operations is described later with reference to FIG. 11.

The reply-instruction accepting unit 115 accepts from the terminal apparatus 31 an instruction for creating a reply mail to an e-mail read at an account for which mail information is provided by the mail-information providing unit 112.

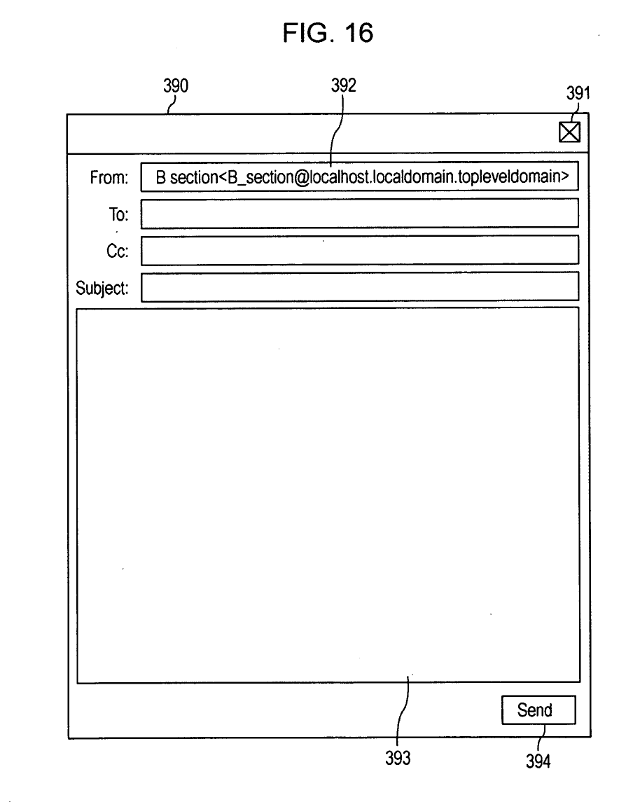

The source-address setting unit 116 sets the mail address of the account at the source of the reply instruction for the e-mail as a source address of the reply mail based on the reply instruction accepted by the reply-instruction accepting unit 115. The display on the browser of the terminal apparatus 31 and user's operation for setting the source address is described later with reference to FIG. 16.

The mail-information processing unit 117 processes the mail information read by the mail-information providing unit 112 and updates the mail information stored in the mail-information storage unit 130 according to an operation instruction accepted by the operation-instruction accepting unit 118. Thus, an e-mail operation performed on the browser of one of the terminal apparatuses 31 and 32 by the user is reflected on the mail information stored at the mail server 100.

The operation-instruction accepting unit 118 accepts an operation instruction for an e-mail operation related to an account determined by the account determining unit 114 as an account a user is allowed to access and perform operations. The operation instruction is input by the user by operating the browser of the terminal apparatus 31, for example. The operation instruction input to the terminal apparatus 31 is sent from the terminal apparatus 31 to the mail server 100 via the LAN 10. For example, the user may issue operation instructions relating to reading an e-mail, deleting an e-mail, creating a reply mail, creating a new e-mail, and so forth using the browser.

The mail-information storage unit 130 stores mail information relating to e-mails. The mail information includes, for example, mail bodies and header information of internal mails created on the browsers of terminal apparatuses inside the organization 30 via the LAN 10, and external mails sent from the outside of the organization 30 via the Internet 20 connected to the mail server 100. The header information includes, for example, information indicating a source address, a destination address, a date and time of sending, and so forth.

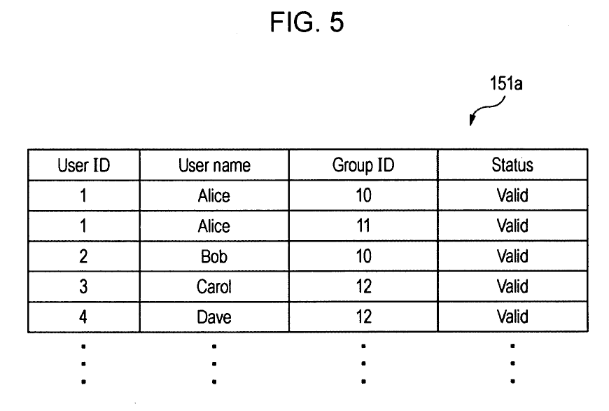

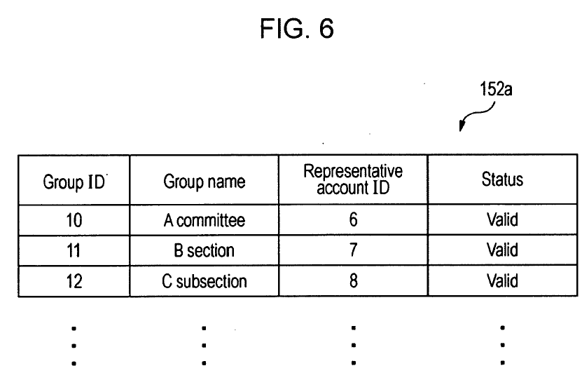

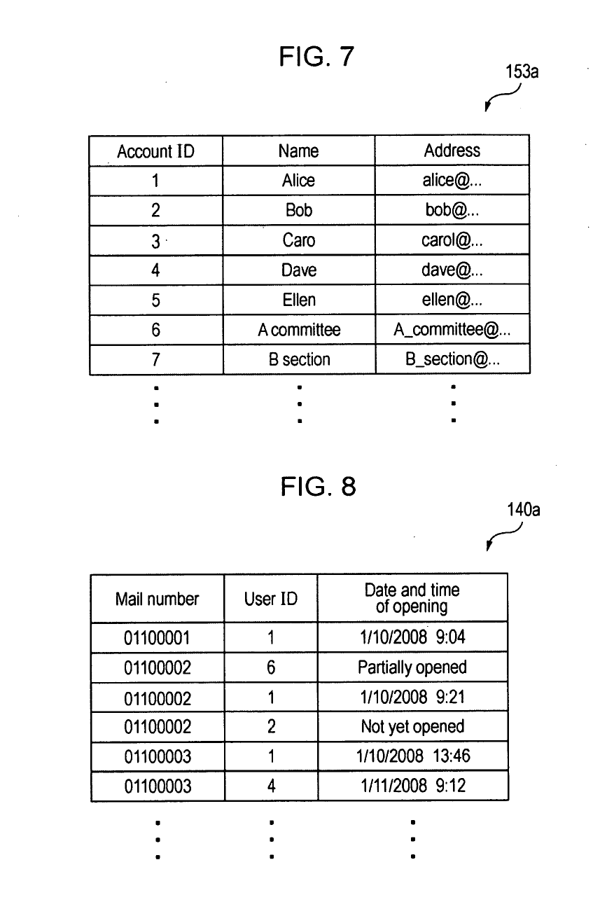

The account-information storage unit 150 stores account information identifying accounts in which users are allowed to perform operations relating to e-mails. The account information storage unit 150 includes an association-information storage unit 151, a group-information storage unit 152, and an address-information storage unit 153, for example. The association-information storage unit 151 stores an association table 151a (see FIG. 5). The group-information storage unit 152 stores a group table 152a (see FIG. 6). The address-information storage unit 153 stores an address table 153a (see FIG. 7).

The mail-opening-information storage unit 140 stores mail opening information indicating whether each e-mail has been opened at the log-in account. The mail-opening-information storage unit 140 stores a mail opening table 140a (see FIG. 8).

In FIG. 4, the terminal apparatus 31 is connected to the mail server 100 via the LAN 10. The terminal apparatus 31 may display information relating to e-mails based on mail information provided from the mail server 100 according to user's operations, for example. Furthermore, the terminal apparatus 31 may output a switching instruction to the mail server 100 according to a user's operation, for example.

While the mail server 100 is described as performing various different operations, the above description is not intended to be limiting. For example, an apparatus different from the mail server 100, such as a dedicated server, for example, may perform at least some of the above noted operations. Yet alternatively, each of a plurality of apparatuses including the mail server 100 may perform part of the operations described above so that the plurality of apparatuses as a whole perform the above noted operations.

FIG. 5 depicts a data structure of an association table. The association table 151a shown in FIG. 5 may be created and managed by the mail server 100. The association table 151a stores association information indicating relationships between individual users belonging to the organization 30 and individual groups of the organization 30.

Referring to FIG. 5, the association table 151a includes “User ID” indicating an identifier (ID) assigned to each user in the organization 30, “user name” indicating a name of the user, “group ID” indicating an ID assigned to a group to which the user belongs, and “status” indicating the validity of the user ID. The items of information in each row are associated with each other. The items of information and associations between the items may be included in association information. Although not shown in FIG. 5, the association information also includes a password used for authentication of the user in combination with the user ID.

The user ID is a code assigned to each user for identification of the user in the mail system, such as the mail server 100, for example. Thus, an arbitrary text string may be used as the user ID as long as the user ID allows unique identification of the user. The user name is a name of a user who belongs to the organization 30 and who uses the mail system.

The group ID is a code assigned to each group and used for identifying the group within the mail system. Thus, similarly to the user ID, an arbitrary code may be used as the group ID as long as the group ID allows unique identification of the group.

The status indicates the validity of the user ID. A “valid” status indicates that the user ID is usable. On the other hand, an “invalid” status indicates that the use of the user ID has been invalidated.

Each user may belong to one or more groups. When a user belongs to a plurality of groups, a plurality of pieces of association information may be created for the user. For example, as shown in the first and second rows from the top of the association table 151a depicted in FIG. 5, the same user ID is associated with different group IDs in individual pieces of association information.

FIG. 6 depicts a data structure of a group table. The group table 152a depicted in FIG. 6 may be created and managed by the mail server 100. The group table 152a stores group information indicating information regarding each group of the organization 30.

Referring to FIG. 6, the group table 152a includes “group ID” indicating an ID of each group of the organization 30, “group name” indicating a name of the group, “representative account ID” indicating a representative account ID for identifying a mail address assigned to the group, and “status” indicating the validity of the group ID. The items of information in each row are associated with each other. The information depicted in FIG. 6 and associations between the information may be included in group information.

As described earlier, the group ID is a code assigned to each group for identification of the group in the mail system. The group name is a name of each group of the organization 30 that uses the mail system.

The representative account ID is a code assigned to each group in order to associate the group with a representative address assigned to the group. Thus, similar to the group ID, an arbitrary text string may be used as the representative account ID as long as the representative account ID allows unique identification of the group.

The status indicates the validity of the group ID. A “valid” status indicates that the group ID is usable. On the other hand, an “invalid” status indicates that the use of the group ID has been invalidated.

FIG. 7 depicts a data structure of an address table. The address table 153a depicted in FIG. 7 may be created and managed by the mail server 100. The address table 153a stores address information indicating address information of each user and each group of the organization 30, for example.

Referring to FIG. 7, the address table 153a includes “account ID” indicating a user ID of a user having a mail address or a group ID of a group having a mail address, “name” indicating a name of the user or group, and “address” indicating the mail address assigned to the user or group. The items of information in each row are associated with each other. The information depicted in FIG. 7 and associations between the information may be included in address information.

The account ID is a code assigned to each user and each group in order to associate each user with a mail address assigned to the user and each group with a representative mail address assigned to the group in the address table 153a. The name is a name of the user or group. The address is the mail address assigned to the user or the representative mail address assigned to the group.

Each group may have one representative address or two or more representative addresses assigned thereto. If two or more representative addresses are associated with a single group, a plurality of pieces of address information may be created for the same group, so that the same account ID (representative address ID) may be associated with different representative mail addresses in the individual pieces of address information.

E-mails received at personal addresses and e-mails received at representative addresses are managed and stored in the mail-information storage unit on an account-by-account basis, for example. A user may issue a request for an e-mail operation from one of the terminal apparatuses 31 and 32. The request may be based on association information, group information, and address information respectively depicted in FIGS. 5 to 7. For each account in which the user is allowed to perform operations, mail information is provided to the terminal apparatus that the user uses. Further, mail bodies, the presence or absence of unopened mails, the number of unopened mails, and so forth are displayed on a browser on an account-by-account basis (see FIGS. 13 to 16), for example. The user who performs e-mail operations may perform operations involving e-mails displayed on the browser, for example.

FIG. 8 depicts a data structure of a mail opening table. The mail opening table 140a depicted in FIG. 8 may be created and managed by the mail server 100. The mail opening table 140a stores mail opening information indicating whether each e-mail received by the mail server 100 has been opened by each user, and a date and time of opening by each user. As described earlier, e-mails include both internal mails and external mails.

The mail opening table 140a includes “mail number” indicating a number uniquely assigned to each e-mail for identification of the e-mail, “user ID” indicating a user who opened the e-mail, and “date and time of opening” indicating whether the e-mail identified by the mail number has been opened at the account corresponding to the user ID and a date and time of opening. The items of information in each row are associated with each other. The items of information depicted in FIG. 8 and associations between the items may be included in mail opening information.

The mail number is a number uniquely assigned to each e-mail received by the mail server 100 for the purpose of identification of the e-mail by the mail server 100. The mail number of an external mail is assigned at the time of reception of the external mail by the mail server 100 via the Internet 20, for example. The mail number of an internal mail is assigned at the time of storage at the mail server 100 of the internal mail sent via the LAN 10 to the mail server 100 after the internal mail is created at one of the terminal apparatuses 31 and 32, for example.

The user ID indicates a user who has opened the e-mail identified by the mail number. More specifically, a mail address to which the e-mail identified by the mail number is addressed is obtained, and a user corresponding to the mail address is recorded. The date and time of opening indicates whether the e-mail identified by the mail number has been opened by the user identified by the user ID, and a date and time of opening by the user.

Each time an external mail sent from the outside of the organization 30 is received and each time an internal mail is created inside the organization 30, the mail server 100 creates mail opening information, which is depicted within each row of the mail opening table 140a. Upon reception of an external mail or creation of an internal mail, “not yet opened” is initially set as the date and time of opening.

The mail opening information is created individually for each e-mail opened and for each account corresponding to a destination of the e-mail. That is, if an e-mail has a plurality of destination addresses, the mail opening information is created for each user to which the e-mail is addressed, (for example, as in the mail opening information on the fifth and sixth rows of the mail opening table 140a depicted in FIG. 8).

Furthermore, if an e-mail is addressed to a representative address (see the e-mail identified by the mail number “01100002” on the second to fourth rows from the top of the mail opening table 140a, for example), mail opening information is created for the group corresponding to the representative address (see the group identified by the user ID “6”, for example), and mail opening information is created for each of a plurality of users belonging to the group corresponding to the representative address (see the three users identified by the user IDs “1”, “2”, and “6”, for example).

Then, each time a user logs in to the mail system and reads an e-mail, the mail server 100 obtains a date and time of opening (e.g., hour, minute and second of the opening, for example). The date and time of opening is written as the date and time of opening in mail opening information corresponding to the mail number assigned to the e-mail read by the user and the user ID indicating the account of the user who opened the e-mail. In the case of an e-mail addressed to a group, if the e-mail has not been opened by all the users but has been opened by some users, “partially opened” is set as the date and time of the opening of the e-mail addressed to the group (see the second row from the top of the mail opening table 140a, for example). Then, when the e-mail has been opened by all the users to which the e-mail is addressed, similarly to the case of a personal user ID, a date and time of opening is written as the date and time of opening corresponding to the user ID of the group for the e-mail.

The mail opening information maintains a record as to whether each e-mail managed by the mail server 100 has been opened by each user. Thus, it is possible to manage whether each e-mail has been read by each user.

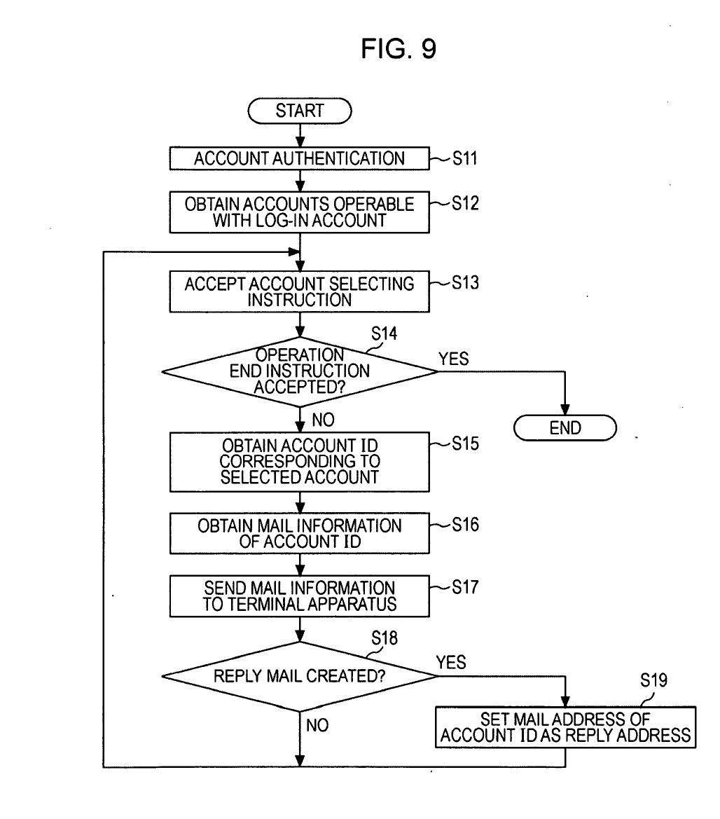

FIG. 9 is a flowchart depicting a mailbox process.

Upon receiving an e-mail operation request sent from one of the terminal apparatuses 31 and 32, (e.g., the terminal apparatus 31, for example) used by a user belonging to the organization 30, the mail server 100 executes the mailbox process to provide the terminal apparatus with information of e-mails addressed to the user. The information is displayed on the browser of the terminal apparatus used by the user belonging to the organization 30.

In step S11, upon receiving an e-mail operation request from the user of the terminal apparatus 31, the CPU 101 of the mail server 100 performs account authentication regarding the user ID of the personal account of the user via the LAN 10, for example. If the account is authenticated, the user is allowed to login to the mail system.

In step S12, the CPU 101 identifies a group ID of a representative account in which the user is allowed to perform operations according to the user ID of the personal account used for login and based on account information such as the account information described earlier (see FIGS. 5, 6, and 7). The identification of a group ID, which may be based of a user ID and account information, is described later with reference to FIG. 11.

In step S13, the CPU 101 accepts an instruction for selecting an account in which the user wishes to perform e-mail operations. Thus, the e-mail account in which the user wishes to perform e-mail operations among the personal address and representative address is reported from one of the terminal apparatuses 31 and 32 to the mail server 100.

In step S14, the CPU 101 determines whether an operation end instruction from one of the terminal apparatuses 31 and 32 has been accepted. If an operation end instruction has not been accepted, the process proceeds to step S15. On the other hand, if an operation end instruction has been accepted, the process is exited.

In step S15, the CPU 101 obtains an account ID (see FIG. 7) corresponding to the e-mail account selected by the user based on a selecting instruction accepted in step S13. Thus, when the user has selected to perform e-mail operations relating to the personal address on the browser of one of the terminal apparatuses 31 and 32, an account ID corresponding to the personal address is obtained. On the other hand, when the user has selected to perform operations relating to the representative address, an account ID corresponding to the representative address is obtained.

In step S16, the CPU 101 obtains mail information corresponding to the account ID obtained in step S15.

In step S17, the CPU 101 sends the mail information obtained in step S16 to the one of the terminal apparatuses 31 and 32 that is the source of the operation request from the user.

In step S18, the CPU 101 determines whether the user has created a reply mail on one of the terminal apparatuses 31 and 32 relating to the account selected in step S13. If the user has created a reply mail, the process proceeds to step S19. On the other hand, if the user has not created a reply mail, the process proceeds to step S13.

In step S19, the CPU 101 sets the mail address of the account ID obtained as a reply address that serves as a source of the reply mail (reply source) created by the user. Thus, when the user replies to an e-mail at the personal address, the user creates a reply mail in which the personal address is set as a reply address. On the other hand, when the user replies to an e-mail at the representative address, the user creates a reply mail in which the representative address is set as a reply address.

The mail server 100 may set a reply address before a user creates a reply mail. However, the mail server 100 may automatically change a reply address to a mail address of a corresponding account after a user creates a reply mail and issues a sending instruction. Yet alternatively, instead of automatically changing the reply address, the mail server 100 may display an alert message or a confirmation message for the user or send an alert message or a confirmation message to a third party in a case where the destination address of the e-mail received does not coincide with the reply address of the reply mail created by the user. Furthermore, these schemes may be used in combination with each other.

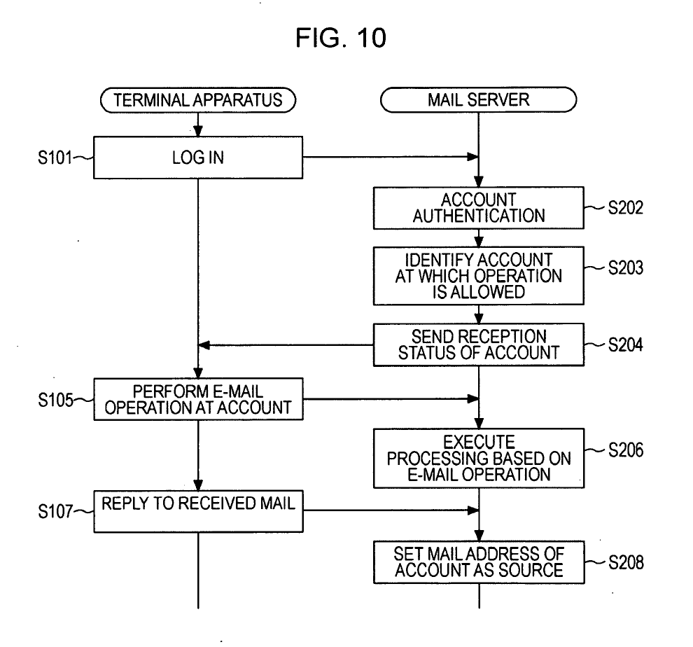

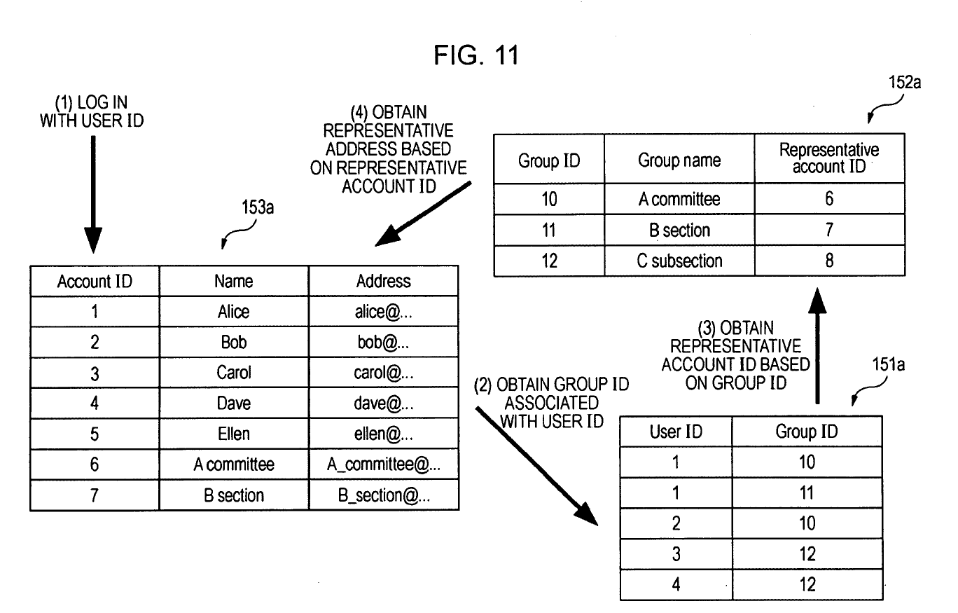

FIG. 10 depicts an e-mail operation by a user in the mail system.

In the mail system, when a user in the organization 30 performs a Web mail operation by using one of the terminal apparatuses 31 and 32 within the organization 30 (e.g., the terminal apparatus 31, for example) on an e-mail, the following procedure may be executed. For example, the e-mail may be either an external mail sent to a personal user or group in the organization 30 from one of the terminal apparatuses 21, 22, and 23 outside the organization 30 or an internal mail created for a personal user or group in the organization 30 at one of the terminal apparatuses 31 and 32 within the organization 30 (e.g., the terminal apparatus 31, for example).

In step S101, the terminal apparatus 31 accepts input of an account ID and a password by a user within the organization 30, and sends the account ID and the password to the mail server 100 via the LAN 10, for example.

In step S202, upon receiving the account ID and password sent from the terminal apparatus 31, the mail server 100 performs account authentication based on the account ID and password received in order to check the validity of the user.

In step S203, the mail server 100 obtains account information indicating an account associated with the account ID of the user who has logged in from the association-information storage unit 151, the group-information storage unit 152, and the address-information storage unit 153 of the account-information storage unit 150. Thus, accounts in which the user who has logged in is allowed to perform operations are identified.

In step S204, the mail server 100 sends information indicating the status of e-mails received for the accounts in which the user is allowed to perform operations to the terminal apparatus 31 via the LAN 10, for example. The information indicating the status of e-mails includes mail opening information (see FIG. 8), for example.

In step S105, when the user has performed an operation using the browser for an e-mail of the user account in which the user is allowed to perform operations, the terminal apparatus 31 sends information corresponding to the e-mail operation to the mail server 100 via the LAN 10.

In step S206, upon receiving the information corresponding to the e-mail operation from the terminal apparatus 31, the mail server 100 executes processing according to the information corresponding to the e-mail operation. The mail information that is sent is mail information of e-mails received at the accounts in which the user who has logged in is allowed to perform operations. The mail information may include data such as mail information of e-mails sent by the user in the past and the body of an e-mail being created, for example.

In step S107, upon an instruction for creating a reply mail to an e-mail based on a user's operation of the browser for an account in which the user is allowed to perform operations, the terminal apparatus 31 sends a reply-mail creating request to the mail server 100 via the LAN 10, for example.

In step S208, upon receiving the reply-mail creating request sent from the terminal apparatus 31, the mail server 100 sets the mail address of the account in which the user received the e-mail as the source. Thus, a reply mail is created in which the address at which the original e-mail was received is set as a source address by the browser on the terminal apparatus 31.

Next, identification of a group ID based on a user ID and related account information is described.

FIG. 11 depicts user accounts and representative accounts as well as associations between the user accounts and representative accounts.

Referring to FIG. 11, (1) a user inside the organization 30 who operates one of the terminal apparatuses 31 and 32 logs in by using a user ID that is set as the account ID in the address table 153a (see FIG. 7, for example). (2) Then, based on the user ID used for login, a group ID associated with the user ID is obtained with reference to the association table 151a (see FIG. 5, for example). (3) Then, based on the obtained group ID, a representative account ID of the group corresponding to the group ID is obtained with reference to the group table 152a (see FIG. 6, for example).

(4) Then, based on the obtained representative account ID, a mail address corresponding to the representative address of the representative account ID is obtained again with reference to the address table 153a (see FIG. 7, for example).

For example, in a case where a personal user “Alice” has logged in with a user ID (account ID) “1” (see the address table 153a of FIG. 11), the user ID “1” is associated with group IDs “10” and “11” (see the association table 151a of FIG. 11). The group IDs “10” and “11” are associated with a representative account ID “6” corresponding to a group name “A committee” and a representative account ID “7” corresponding to a group name “B section”, respectively (see the group table 152a of FIG. 11). Furthermore, these representative account IDs “6” and “7” are associated with a representative address “A_committee@ . . . ” of the A committee and a representative address “B_section@ . . . ” of the B section, respectively.

Thus, the account information indicates that, in this mail system, Alice is allowed to perform operations involving e-mails received at the representative addresses of the A committee and the B section.

Next, display screens displayed on the browsers of the terminal apparatuses 31 and 32 when a mailbox process is executed is described.

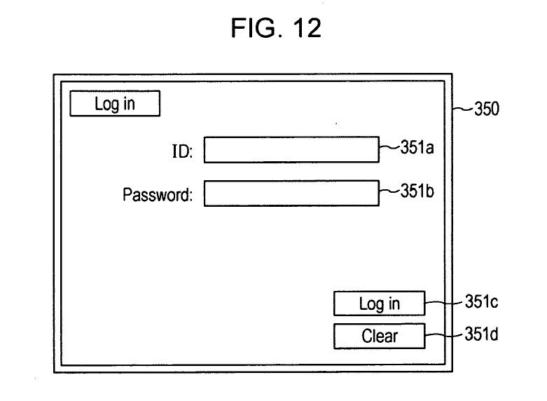

FIG. 12 depicts a log-in screen. The log-in screen 350 shown in FIG. 12 is an example of a log-in screen displayed on a browser on a monitor (not shown) connected to one of the terminal apparatuses 31 and 32 (e.g., the terminal apparatus 31, for example) operated by a user inside the organization 30. The log-in screen may be used by a user during a log-in operation for logging into the mail system in order to perform e-mail operations.

Referring to FIG. 12, the log-in screen 350 includes an ID input field 351a, a password input field 351b for accepting input of a password, a log-in button 351c for accepting an operation for causing the mail server 100 to execute account authentication for login when the ID and password respectively input to the ID input field 351a and the password input field 351b are valid. The log-in screen 250 also includes a clear button 351d for an operation an operation of canceling information that has been input when the ID and password input to the ID input field 351a and the password input field 351b.

A user who logs into the mail system inputs a user ID to the ID input field 351a and a password associated with the user ID to the password input field 351b. The user ID and password may be assigned in advance. Once the user has input the user ID and password, the user may trigger the log-in button 351c. The mail server 100 executes account authentication in response to the triggering of the log-in button 351c.

FIG. 13 depicts a post-log-in screen. The post-log-in screen 360 depicted in FIG. 13 is an example of a post-log-in screen displayed on the browser on the monitor (not shown) connected to one of the terminal apparatuses 31 and 32 (e.g., the terminal apparatus 31, for example) operated by the user in the organization 30. The post-log-in screen 360 may be displayed after the user logs into the mail system to perform e-mail operations.

Referring to FIG. 13, the post-log-in screen 360 includes account selecting buttons 361a, 361b, and 361c for selecting an account, a close button 361d for finishing an e-mail operation, a folder display area 362 for displaying the status of e-mail folders relating accounts in which the user is allowed to perform operations, and an account-information display area 363 for displaying the status of reception of e-mails at the account that the user has logged into.

In the folder display area 362, accounts in which the user is allowed to perform operations (e.g., “personal”, “B section”, and “C subsection”, for example), and folders of the accounts (e.g., “inbox”, “sent items”, “deleted items”, “forms”, and “complaints”, for example) are displayed.

In the folder display area 362, for each of the personal and representative addresses corresponding to the accounts in which the user is allowed to perform operations, the number of unopened (unread) mails is displayed on a folder-by-folder basis.

More specifically, referring to FIG. 13, “Inbox (10)” for the personal address indicates that 10 unopened mails exist in the inbox folder of the personal address. Furthermore, “Inbox (25)” for the B section indicates that 25 unopened mails exist in the user's account at the representative address of the B section. The mail server 100 may determine whether each e-mail has been opened or not with reference to the mail opening information stored in the mail opening table 140a (see FIG. 8).

In the account-information display area 363, the mail address of the account that the user has logged into, and the status of reception at the mail address, such as the number of unopened mails and the amount of storage currently used, for example, are displayed. For example, in the case where the user has logged in with the personal address, the status of reception at the personal address is displayed in the account-information display area 363.

A user who has logged into the mail system may recognize the presence or absence of unopened mails and the number of unopened mails at each account with reference to the folder display area 362. In the case where the user performs e-mail operations at an account having any unopened mail, the user can switch to account display screens 370 and 380 by operating one of the account selecting buttons 361a, 361b, and 361c. If the user does not wish to perform e-mail operations at any of the accounts, the user can log out of the mail system using the close button 361d.

FIG. 14 depicts an account display screen for a personal address. The account display screen 370 depicted in FIG. 14 is an example of an account display screen displayed on the browser on the monitor (not shown) connected to one of the terminal apparatuses 31 and 32 (e.g., the terminal apparatus 31, for example) operated by the user inside the organization 30. The account display screen 370 depicts e-mails received at the personal address.

Similarly to the post-log-in screen 360, the account display screen 370 includes account selecting buttons 371a, 371b, and 371c, a close button 371d, and a folder display area 372. Furthermore, in the account display screen 370, a list display area 373 for displaying a list of e-mails in a folder selected in the folder display area 372, a body display area 374 for displaying the body of an e-mail selected in the list display area 373, and a reply button 375 used when the user creates a reply to the e-mail displayed in the body display area 374 are provided.

Referring to FIG. 14, the account selecting button 371a, corresponding to the personal account, is displayed in white. On the other hand, the other account selecting buttons 371b and 371c are displayed as shaded. This indicates that the account of e-mails displayed in the list display area 373 relate to the personal account. The user may switch the e-mails displayed to e-mails of other accounts corresponding to the account selecting buttons 371b and 371c by operating the account selecting buttons 371b and 371c. Furthermore, the user may log out of the mail server and close the display of e-mails by using the close button 371d.

When the user wishes to create a reply mail to an e-mail viewed at the personal account displayed in the body display area 374, the user operates the reply button 375 to open a reply-mail creating screen 390, which is described later with reference to FIG. 16.

FIG. 15 depicts an account display screen for a representative address. The account display screen 380 shown in FIG. 15 is an example of an account display screen displayed on the browser on the monitor (not shown) connected to one of the terminal apparatuses 31 and 32 (e.g., the terminal apparatus 31, for example) operated by the user inside the organization 30. The account display screen 380 depicts e-mails received at the personal address of the B section, which is one of the representative addresses.

Similarly to the account display screen 370 shown in FIG. 14, the account display screen 380 includes account selecting buttons 381a, 381b, and 381c, a close button 381d, a folder display area 382, a list display area 383, a body display area 384, and a reply button 385.

In FIG. 15, the account selecting button 381b, corresponding to the representative account of the B section, is displayed in white. On the other hand, the other account selecting buttons 381a and 381c are displayed as shaded. This indicates that the account of e-mails displayed in the list display area 383 is the representative account of the B section. The user may switch the e-mails displayed to e-mails of other accounts corresponding to the account selecting buttons 381a and 381c by operating the account selecting buttons 381a and 381c. Furthermore, the user may log out of the mail server and close the display of e-mails using the close button 381d.

When the user wishes to create a reply mail to an e-mail viewed at the representative account displayed in the body display area 384, the user operates the reply button 385 to open a reply-mail creating screen 390, which is described later with reference to FIG. 16.

FIG. 16 depicts a reply-mail creating screen. A reply-mail creating screen 390 depicted in FIG. 16 is an example of a reply-mail creating screen displayed on the browser on the monitor (not shown) connected to one of the terminal apparatuses 31 and 32 (e.g., the terminal apparatus 31, for example) operated by the user inside the organization 30. The reply-mail creating screen 390 may be displayed when the user creates a reply mail responding to an e-mail that the user has read.

Referring to FIG. 16, the reply-mail creating screen 390 includes a close button 391, a source-address input field 392 for accepting input of a sender address at the source of the reply mail (reply source), a body input area 393 for accepting input of a body of the reply mail, and a send button 394 that is operated by the user when sending a created reply mail.

Referring to FIG. 14 or 15, when the user has read the e-mail displayed in the body display area 374 or 384 and wishes to create a reply mail to the e-mail, the user operates the reply button 375 or 385 to open the reply-mail creating screen 390 on the browser at the terminal apparatus 31. The user may create a reply mail by entering a mail body in the body input area 393.

In the source-address input field 392, the mail address of the account at which the e-mail to which a reply mail is being created was read may be input automatically, prior to entering of the mail body in the body input area 393. More specifically, for example, as depicted in FIG. 15, when the user creates a reply mail to an e-mail read at a representative account, as shown in FIG. 16, the representative address (e.g., the mail address of the representative account at which the e-mail was read, for example) is input as a source address. When the user creates a reply mail to an e-mail read at the personal account as shown in FIG. 14, the personal address (e.g., the mail address of the personal account at which the e-mail was read, for example) is input as a source address.

Thus, an appropriate source address is set in the reply mail created by the above-described mail system. Accordingly, it is possible to reduce the likelihood of a mistake resulting in the sending an e-mail to the incorrect address.

As described above with respect to examples of embodiments of the present invention, users registered at the mail server 100 may readily share information regarding e-mails addressed to a representative address, which has not been possible in related Web mail systems.

Furthermore, in addition to information displayed in related systems when a user has logged in to a personal account, it also possible to visually recognize the status of reception of e-mails at a representative address according to examples of embodiments of the present invention.

Furthermore, the mail boxes of groups to which a user of an account used for log n belongs may be displayed and easily switched between by using the account selecting buttons 361a to 381c. Thus, the user need not perform separate logins for each of a plurality of accounts according to examples of embodiments of the present invention, which facilitates a user's management of e-mails of the plurality of accounts.

As described above, since it is possible to perform switching of an e-mail account that a user uses to perform operations among a plurality of accounts without logging in again, it is also possible to display emails relating to different accounts without have to login again.

Furthermore, since the presence or absence of any unopened mails and the number of unopened mails are displayed in the post-log-in screen 360 and the received-mail display screen, even for an account different from an account for which mail information is displayed in the post-log-in screen 360 and the account display screens 370 and 380, without selecting all the accounts one by one, it is possible to determine whether mail information of other accounts should be displayed. This serves to reduce user's tasks for mail management.

Hereinabove, a mail sending and receiving program stored on a computer-readable medium, a mail sending and receiving apparatus, and a mail sending and receiving system according to example of embodiments of the present invention have been described. Although the above description explains the principle of the present invention through the descriptions of examples of embodiments of the present invention, the present invention is not intended to be limited to the exact examples of embodiments of the present invention described above. It is to be understood that various modifications and alternatives may be conceived by those skilled in the art. All corresponding modifications, alternatives, and equivalents are considered as falling in the scope of the present invention as claimed and its equivalents. The configuration of individual parts may be replaced with arbitrary configurations having similar functions. Furthermore, arbitrary configurations or steps may be added when embodying the present invention. Furthermore, the present invention covers a combination of two or more configurations (features) of the embodiments described above.

The above processing may be implemented by a computer, for example. In that case, a program defining processing for intended functions of the mail server 100 is provided. The processing functions are implemented by the computer executing the program stored on a computer-readable recording medium.

The computer-readable recording medium is, for example, a magnetic recording medium, an optical disc, a magneto-optical recording medium, or a semiconductor memory. The magnetic recording medium is, for example, an HDD, an FD (flexible disk), or an MT (magnetic tape). The optical disc is, for example, a DVD (digital versatile disc), a DVD-RAM, a CD-ROM (compact disc read-only memory), or a CD-R (recordable)/RW (rewritable). The magneto-optical recording medium is, for example, an MO (magneto-optical disk).

In order to distribute the program, for example, a portable recording medium having the program stored thereon, such as a DVD or CD-ROM, for example, may be sold. Alternatively, the program may be stored at a server computer and transferred from the server computer to another computer via a network.

For example, a computer that executes the program installs the program recorded on the portable recording medium or transferred from the server computer on a storage device of its own. Then, the computer reads the program from the storage device and executes processing according to the program. Alternatively, the computer may read the program directly from the portable recording medium and execute processing according to the program. Yet alternatively, the computer may execute processing according to the program each time upon receiving the program from the server computer

At least one embodiment of the present invention may also be embodied as machine-readable data including executable instructions that are recorded on a machine-readable recording medium. The machine-readable recording medium is any data storage device that can store the data, including the executable instructions, and which can be read by a machine, e.g., a computer system, so as to provide the machine with the executable instructions included in the recorded data for execution.

Examples of embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made therein without departing from the spirit and scope of the present invention as set forth in the claims.

What is claimed is:

1. A recording medium storing a mail sending and receiving program, which when executed by a computer, causes the computer to perform a method, the method comprising:
performing authentication for login by a user to an entry account from which the user manages e-mails;
reading account information from a first memory, the account information identifying one or more other accounts for which the user is allowed to perform operations involving the e-mails;
determining accounts for which the user is authenticated and allowed to perform operations involving the e-mails with reference to the account information;
accepting an operation instruction for performing an operation involving an e-mail at any one of the determined accounts; and
performing an operation based on the accepted operation instruction.

2. The recording medium according to claim 1, the method further comprising:
reading mail information regarding e-mails of the determined accounts from a second memory storing mail information relating to e-mails;
providing the mail information that has been read for each of the determined accounts; and
updating the mail information stored in the second memory according to the accepted operation instruction.

3. The recording medium according to claim 1, the method further comprising:
receiving a switching instruction; and
switching the account for which the mail information is provided from one account to another account among the determined accounts based on the received switching instruction.

4. The recording medium according to claim 1, the method further comprising:
reading mail opening information from a third memory storing the mail opening information, the mail opening information indicating whether each e-mail has been opened at the determined accounts.

5. The recording medium according to claim 4, the method further comprising:
displaying unopened mail information based on the mail opening information that has been read, the unopened mail information indicating whether any unopened mail exists in each of the accounts.

6. The recording medium according to claim 2, the method further comprising:
accepting a reply instruction for creating a reply mail to a read e-mail of one of the determined accounts; and
setting a mail address of the one of the determined accounts corresponding to the read email as a source address of the reply mail based on the accepted reply instruction.

7. The recording medium according to claim 1, wherein the performed authentication allows a user to perform operations on the determined accounts without having to login to each of the accounts separately.

8. The recording medium according to claim 1, wherein the emails include Web mails and the performed operation includes a Web mail operation.

9. A mail sending and receiving apparatus for sending and receiving e-mails, the apparatus comprising:
an authentication unit to perform authentication for login by a user to an entry account at which the user manages e-mails;
a first memory to store account information identifying one or more other accounts for which the user is allowed to perform operations involving the e-mails;
a second memory to store mail information relating to the e-mails;
an account determining unit to read the account information from the first memory, and determine the accounts for which the user is authenticated by the authentication unit and allowed to perform operations involving the e-mails with reference to the account information; and
an operation-instruction accepting unit to accept an operation instruction for performing an operation involving an e-mail at any one of the accounts determined by the account determining unit.

10. The apparatus according to claim 9, further comprising:
a mail-information providing unit to read mail information regarding the e-mails of the accounts determined by the account determining unit from the second memory, and provide the mail information that has been read for each of the accounts determined by the account determining unit; and
a mail-information processing unit to process the mail information read by the mail-information providing unit and update the mail information stored in the second memory according to the operation instruction accepted by the operation-instruction accepting unit.

11. The apparatus according to claim 10, further comprising:
a switching-instruction accepting unit to accept a switching instruction and switch the account for which the mail information is provided by the mail-information providing unit from one account to another account among the accounts determined by the account determining unit.

12. The apparatus according to claim 9, wherein
the mail-information providing unit reads mail-opening information from a third memory storing the mail opening information, the mail opening information indicating whether each e-mail has been opened at the determined accounts, and generates unopened mail information indicating whether any unopened mail exists in each of the accounts determined by the account determining unit with reference to the mail opening information read from the third memory.

13. The apparatus according to claim 9, wherein the emails include Web mails and the performed operation includes a Web mail operation.

14. A mail sending and receiving system for sending and receiving e-mails, the system comprising:
a mail sending and receiving apparatus; and
a terminal apparatus connected to the mail sending and receiving apparatus via a communication circuit,
wherein the mail sending and receiving apparatus includes:
an authentication unit to perform authentication for login by a user to an entry account for which the user manages the e-mails;
a first memory to store account information identifying one or more other accounts for which the user is allowed to perform operations involving the e-mails;
a second memory to store mail information relating to the e-mails;
an account determining unit to read the account information from the first memory, and determine the accounts for which the user is authenticated by the authentication unit and allowed to perform operations involving the e-mails with reference to the account information; and
an operation-instruction accepting unit to accept an operation instruction for performing an operation involving an e-mail at any one of the accounts determined by the account determining unit, and
the terminal apparatus displays information regarding e-mails provided from the mail sending and receiving apparatus according to an operation by the user.

15. The system according to claim 14, wherein the mail sending and receiving apparatus further includes:
a mail-information providing unit to read mail information regarding e-mails of the accounts determined by the account determining unit from the second memory, and provide the mail information that has been read for each of the accounts determined by the account determining unit; and
a mail-information processing unit to process the mail information read and provided by the mail-information providing unit and update the mail information stored in the second memory according to the operation instruction accepted by the operation-instruction accepting unit.

16. The system according to claim 15, wherein the mail sending and receiving apparatus further includes:
a switching-instruction accepting unit to accept a switching instruction and switch the account for which the mail information is provided by the mail-information providing unit from one account to another account among the accounts determined by the account determining unit.

17. The system according to claim 16, wherein the terminal apparatus outputs the switching instruction and the operation instruction to the mail sending and receiving apparatus according to operations by the user, and
wherein the mail-information providing unit switches the account for which the mail information is read from the mail-information providing unit and is provided from the one account to the another account according to the switching instruction accepted by the switching-instruction accepting unit.

18. The system according to claim 14, wherein the emails include Web mails and the performed operation includes a webmail operation.
